(19) United States
(12) Patent Application Publication
(10) Pub. No.: US 2018/0142182 A1
(43) Pub. Date: May 24, 2018

(54) Method for Making Electrorheological Fluids

(71) Applicant: Dow Global Technologies LLC, Midland, MI (US)

(72) Inventors: Kishore K. Kar, Midland, MI (US); David J. Adrian, Midland, MI (US); Daniel J. Arriola, Midland, MI (US); Ravindra S. Dixit, Lake Jackson, TX (US); Tobias Drogseth, Zurich (CH); Michael P. Staloch, Midland, MI (US)

(73) Assignee: Dow Global Technologies LLC, Midland, MI (US)

(21) Appl. No.: 15/579,597

(22) PCT Filed: Jun. 2, 2016
(86) PCT No.: PCT/US16/35568

§ 371 Date: Dec. 4, 2017

Related U.S. Application Data
(60) Provisional application No. 62/181,236, filed on Jun. 18, 2015.

(51) Int. Cl. C10M 171/00; C10M 149/14; C10M 107/50; C08G 18/08; C08J 3/09; C10M 177/00

(52) U.S. Cl. CPC C10M 171/001; C10M 149/14; C10M 107/50; C08G 18/0871; C08J 3/098; C10M 177/00; C08J 2483/04; C10M 2227/045; C10N 2220/082; C10N 2230/60; C10N 2240/08; C08J 2375/04; C10M 2217/041

(57) ABSTRACT

Dispersions are prepared by dispersing a polymer precursor such as a polyol into a non-aqueous fluid. The resulting droplets of the polymer precursor is partially polymerized to produce liquid or partially gelled droplets, and then sized to a target particle size. The sized particles are then cured to form solid particles. The process allows for close control of particle size, allows for good control of temperature, and is amenable to batch, semi-continuous or even continuous operation. The resulting dispersions are useful as electrorheological fluids.

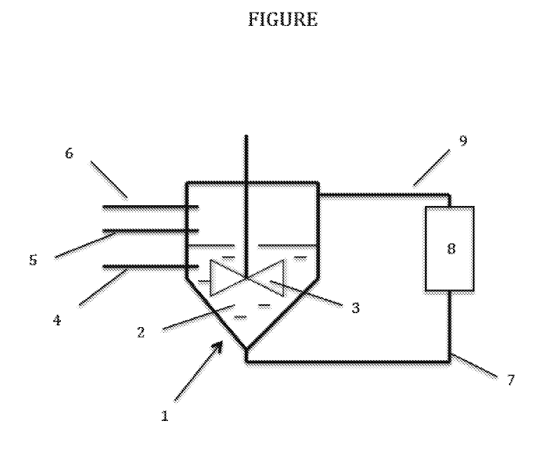

The present invention relates to a method of making an electrorheological fluid in which polymer particles are dispersed in a non-aqueous fluid.

Electrorheological fluids are dispersions of small particles in a hydrophobic and electrically non-conducting liquid. The apparent viscosity of the electrorheological fluid is reversibly variable with an applied electrical field. In the presence of an electrical field, the dispersed particles polarize and agglomerate, which leads to a large increase in apparent viscosity. When the electrical field is removed, the particles redisperse and the apparent viscosity returns to approximately its original value. This property makes the fluids useful in applications such as “tunable” vehicular suspension systems, hydraulic clutches, hydraulic valves, braking systems, devices for positioning and fixing workpieces, exercise and sport devices, and other variable resistance devices.

As described in U.S. Pat. No. 5,948,852 and US 2015/0080279, electrorheological fluids can be prepared in an in-situ method, in which the dispersed phase particles are formed by dispersing droplets of a polymer precursor into a hydrophobic and non-conducting liquid, and then curing the droplets to form dispersed polymer particles. The polymer precursor is dispersed into droplets using impingement-mixing methods. Impingement mixing methods have several serious drawbacks. Large pressure drops are needed. Localized high temperatures form. This heat must be dissipated quickly to avoid thermal oxidation. The curing step is slow because a curing agent must be added after the precursor is dispersed. It is necessary to add the curing agent slowly to avoid gel formation. The slow addition leads to long batch times. The process is not easily scalable to large production rates and volumes.

A faster, easily-scalable process for making these electrorheological fluids is therefore desired. The process should produce a fine dispersion of polymer particles in the continuous phase.

This invention is a method of forming a rheological fluid. The method comprises the steps of:

a) dispersing (1) at least one curable polymer precursor that has reactive groups which engage in a curing reaction to form a cured polymer into (2) a non-aqueous liquid in which the curable polymer precursor is substantially insoluble, to form a dispersion of droplets of the at least one curable polymer precursor in a continuous phase of the non-aqueous liquid;

b) forming a partially cured dispersion by curing the curable polymer precursor in the dispersed droplets to the extent of 1 to 25% of full cure without solidifying the droplets, to form partially cured droplets;

c) sizing the partially cured droplets to a final target droplet size range; and then

d) under non-resizing conditions, curing the curable polymer precursor in the sized, partially cured droplets to form a dispersion of solid polymer particles in the non-aqueous fluid.

The process has the advantages of being fast, efficient, capable of being operated semi-continuously, and of being scalable to large production volumes. The size of the dispersed polymer particles is easily controllable. Narrow particle size distributions are also obtained.

The FIGURE is a schematic diagram of an embodiment of the process of the invention.

In step a) of the process, at least one curable polymer precursor is dispersed into a non-aqueous liquid in which the curable polymer precursor is substantially insoluble. In step a), droplets of the solution form in a continuous phase of the non-aqueous liquid.

The curable polymer precursor(s) can be any liquid compound or liquid mixture of compounds that have one or more reactive groups, and which form a solid organic polymer through one or more chemical reactions of the reactive groups. A polymer precursor may be a single compound that can polymerize to form the organic polymer. A polymer precursor may be a mixture of two or more compounds that react with each other to form the organic polymer.

The curable polymer precursor or mixture of precursors should have a viscosity of no greater than 30,000 mPa·s at 22° C. The viscosity may be no greater than 10,000 mPa·s or no greater than 2,000 mPa·s at 22° C.

Suitable polymer precursors include, for example, compounds having polymerizable vinyl unsaturation; acrylate and methacrylate monomers; primary and/or secondary amine compounds; epoxy resins; polycarboxylic acids (and derivatives such as the corresponding acid halides and anhydrides), and other compounds that engage in addition and/or condensation reactions to form solid polymers.

Polymer precursors that cure in a reaction with a curing agent having one or more coreactive groups are advantageous, because the extent of curing during the partial polymerization step in such cases can be controlled though the amount of curing agent that is added. Examples of precursor/curing agent combinations include, for example, epoxy resins and epoxy curing agents such as amines, thiols and polyisocyanates; polyols and polyisocyanate compounds; polycarboxylic acids (or corresponding acid halides or anhydrides) and polyols; compounds having acrylate, methacrylate, vinyl or allylic unsaturation and amine and/or thiol compounds, and the like. In any of these combinations, either of the materials can be employed herein as the polymer precursor (which is dispersed into the continuous phase), and either of the other materials can be employed herein as the curing agent. In all cases, any material or materials dispersed in the non-aqueous fluid during step a) is considered as the “polymer precursor”, for purposes of this invention.

A preferred polymer precursor or mixture of precursors includes at least one polyol, which is then cured by the addition of at least one polyisocyanate compound. Such polyol(s) contain an average of at least two hydroxyl groups per molecule. The polyol(s) may contain an average of up to 8 or more hydroxyl groups per molecule. The polyol(s) preferably contain an average of 2 to 4 hydroxyl groups per molecule. The equivalent weight per hydroxyl group of each such polyol may be 50 to 3000, but is preferably 200 to 1500 and more preferably 250 to 500; if a mixture of polyols is used, the number average equivalent weight of the mixture is preferably 200 to 1500 and more preferably 250 to 500. The hydroxyl groups may be primary or secondary, although polyols(s) having mainly (at least 50 number percent) primary hydroxyl groups are preferred due to their advantageous cure rates when reacted with polyisocyanates.

Polyether polyols having hydroxyl equivalent weights of 200 to 500 are especially useful polymer precursors. Such polyether polyols may be polymers of, for example, 1,2-propylene oxide, ethylene oxide, 1,2- and/or 2,3-butylene oxide, tetrahydrofuran or other 1,2-epoxide, or a mixture of any two or more thereof. Polymers of ethylene oxide or a mixture of ethylene oxide and 1,2-propylene oxide are especially preferred, as such polyols typically have low solubility in the non-aqueous liquid and are good solvents for salts that are preferably present to increase the electrical conductivity of the dispersed polymer particles.

A conductive component preferably is included in the dispersion formed in step a). Such a conductive component becomes dissolved in and/or migrates to the surface of the polymer particles formed in the process. The conductive component preferably is soluble in the polymer precursor and is preferably introduced into the dispersion by dissolving it into at least a portion of the polymer precursor and dispersing the resulting solution into the non-aqueous liquid in step a) of the process. The conductive component in some embodiments is a salt of a metal ion and one or more counterions. Examples of such salts include KCl, LiNO₃, sodium acetate, LiClO₄, Mg(ClO₄)₂, KSCN, ZnCl₂, LiCl, LiBr, LiI, LiBF₄, NaB(CGHS)₄, LiCF₃SO₃ and N(C₂H₄)₄Cl. Also useful as the conductive component are organic semiconductors that have a greater affinity for the polymer precursor than for the non-aqueous liquid, such as hydrocarbon particles, polyaniline and derivatives thereof, polythiophene and derivatives thereof, and polyacene quinones.

The amount of the conductive component, when used, may be from 0.01 to 1 weight percent, based on the weight of the polymer precursor.

The non-aqueous liquid is a material, liquid at 22° C., in which the polymer precursor and any salt as described below are insoluble (i.e., the polymer precursor and the salt each have a solubility of less than 2 weight-% in the non-aqueous liquid at 22° C.). The non-aqueous liquid should have a freezing temperature of −30° C. or lower and a boiling temperature of at least 150° C. at one atmosphere pressure. Its viscosity is preferably between 3 and 300 mPa·s at 22° C.

By “non-aqueous”, it is meant the non-aqueous liquid contains no more than 500, preferably no more than 100 parts by weight water per million parts by weight of the liquid. The non-aqueous liquid preferably is hydrophobic, which for purposes of this invention means that water is soluble in the non-aqueous liquid to the extent of no more than 0.5%, preferably no more than 0.1%, by weight at 22° C.

The non-aqueous liquid preferably is electrically non-conducting, which, for purposes of this invention, means that the liquid has an electrical resistivity of at least 10¹⁰ ohm-meters, preferably at least 10¹⁵ ohm-meters at 20° C.

Examples of the non-aqueous liquid include liquid hydrocarbons such as n-nonane, 1-nonoene, (cis, trans)-4-nonene and xylene, and silicone oils such as polydimethylsiloxanes and liquid methylphenylsiloxanes. Fluorine-containing polysiloxanes as described in U.S. Pat. No. 5,948,852 are also useful.

The amounts of polymer precursor, curing agent (if any) and non-aqueous liquid preferably are selected together such that the dispersion formed in the process contains 20 to 65, preferably 35 to 60, and more preferably 40 to 60, weight percent dispersed polymer particles.

A surfactant may be present during step a) (and subsequent steps) of the process to help form a stable dispersion. The surfactant preferably is a non-ionic type. Suitable surfactants include, for example, block copolymers of propylene oxide and ethylene oxide; polyoxyethyleglycol alkyl ethers; glucoside alkyl ethers, polyoxyethylene glycol alkylphenol ethers, sorbitan alkyl esters, polysiloxane/polyether copolymers and amino-siloxanes. The surfactant may have reactive groups that react with a polymer precursor and/or curing agent to bind the surfactant to the polymer particles that form in the process. A preferred type of surfactant is a polysiloxane/polyether copolymer, which optionally includes hydroxyl, primary amino and/or secondary amino groups.

The surfactant, when used, is used in small amounts, such as from 0.1 to 10, preferably from 0.5 to 3 parts by weight per 100 parts by weight of the non-aqueous fluid. The surfactant is conveniently dissolved in at least a portion of the non-aqueous fluid before performing step a) of the process, although it can be added as a separate ingredient or as a mixture with the polymer precursor if desired.

The formation of droplets in step a) of the process is conveniently achieved by agitating a mixture of the polymer precursor(s) and non-aqueous liquid. The mixture can be formed by adding the polymer precursor(s) to the non-aqueous liquid, or by adding the non-aqueous liquid to the polymer precursor(s). The volume ratio of polymer precursor(s) to non-aqueous liquid is such that upon dispersing the materials together, the non-aqueous liquid forms a continuous phase and the polymer precursor(s) form a disperse phase. The volume ratio may be, for example 5:95 to 60:40, 20:80 to 55:45 or 35:65 to 55:45.

In step a), the polymer precursor(s) are dispersed into the non-aqueous fluid through the application of energy, which can be accomplished, for example, mechanically (such as by agitation using any agitating means), by ultrasonic methods, or other suitable means.

In some embodiments, the dispersion formed in step a) is a coarse dispersion in which the droplets are quite large relative to the size of the final polymer particles. Droplet and particle size distributions can be expressed in terms of d×x values of the cumulative volume distribution, where “d” represents a specific particle diameter and “xx” denotes the decimal fraction of the total volume of particles that are equal to or smaller than that specific particle diameter. Thus, d₁₀, d₅₀ and d₉₀ values respectively indicate a droplet diameter which is equal to or larger than the diameters of 10 volume percent, 50 volume percent and 90 volume percent of the droplets.

The coarse droplets formed in step a) may be characterized in having a d₅₀ diameter of, for example, at least 200% of that of the final target droplet size obtained in step c) of the process. The d₅₀ diameter of the coarse droplets may be at least 300%, at least 500% or at least 1000% of the final d₅₀ target droplet diameter, and may be up to 5000% of the final d₅₀ target droplet diameter obtained in step c). In absolute terms, the coarse droplet size range may be such that the d₅₀ diameter is at least 20 μm, at least 100 μm or at least 500 μm, up to 10,000 μm, up to 5,000 μm or up to 2500 μm, or up to 1000 μm.

Step a) preferably further includes a preliminary droplet sizing step a-1) in which the droplets are sized to a preliminary target droplet size range. A broad preliminary target droplet size range may be, for example, from 100 nm to 100 μm. More preferably, the preliminary target droplet size range is close to the final target droplet size range that is established in step c) of the process, and may be the same as the final target droplet size range.

The preliminary target droplet d₅₀ diameter obtained in step a-1) may be, for example, 50 to 200%, 75 to 150%, 75 to 130% or 90 to 110% of the final d₅₀ target droplet diameter obtained in step c). In absolute terms, the preliminary target droplet size range may be such that the d₅₀ diameter is 0.5 to 10 μm, preferably 0.5 to 7 μm and especially 0.5 to 5 μm, and/or the d₉₀ is up to 25 μm, preferably up to 10 μm and more preferably 5 to 10 μm.

Droplet and particle size distributions can be expressed in terms of d₁₀, d₅₀ and d₉₀ as follows:

U=d₉₀−d₁₀/d₅₀

Smaller values of U indicate a more uniform droplet size distribution. In some embodiments, the value of U in the droplets formed in preliminary sizing step a-1) is up to 5, preferably up to 2.5 and more preferably up to 1.7.

The preliminary sizing step a-1) is generally performed by subjecting the mixture of polymer precursor(s) and non-aqueous liquid to shearing conditions sufficient to disperse the polymer precursor into droplets of the preliminary target particle size. The preliminary droplet sizing step a-1) in some embodiments is performed simultaneously with the initial mixing of the polymer precursor and non-aqueous fluid. In such embodiments, the polymer precursor(s) are dispersed into the non-aqueous fluid under conditions sufficient to size the droplets into the preliminary target droplet size range.

In other embodiments, the optional preliminary droplet sizing step a-1) is performed after the formation of an initial dispersion of polymer precursor into the non-aqueous fluid. In such embodiments, the initial dispersion is formed under relatively low shear conditions, to produce a coarse dispersion in which the droplet size range is somewhat larger than the preliminary target size range. Simple agitation in, for example, an agitated tank reactor is often sufficient to produce such a coarse dispersion. Various types of static mixing methods, in which the mixture of polymer precursor(s) and non-aqueous liquid is passed through one or more static mixing elements, also can be used. Jet impingement methods, in which high velocity streams of polymer precursor(s) and non-aqueous liquid are impingement mixed, can be used, but are less preferred and preferably avoided. The optional preliminary droplet sizing step a-1) is then performed by subjecting the coarse dispersion to conditions sufficient to break up the droplets into the preliminary target size range.

The optional preliminary droplet sizing step a-1) generally requires higher shear conditions than are needed to simply produce a coarse dispersion. A preferred way of performing the optional preliminary droplet sizing step a-1) is to pass the mixture of polymer precursor(s) and non-aqueous liquid (which mixture may be already formed into a coarse dispersion) one or more times through a homogenizer such as a rotor-stator or an ultrasonic homogenizer.

Conditions for the droplet-forming step a) and optional preliminary droplet sizing step a-1) (if performed) are selected such that the polymer precursor(s) and non-aqueous liquid remain as liquids during those steps, and further such that the polymer precursor(s) do not polymerize. Thus, the temperature and pressure are selected together such that the starting materials do not solidify or volatilize. Conditions are selected such that at least one condition necessary for the polymerization of the polymer precursor(s) is absent. The absent condition may be (depending on the specific polymer precursor(s)) one or more of 1) a temperature needed for polymerization to occur, 2) the presence of a catalyst and/or initiator compound, 3) the presence of a curing agent that is necessary for the polymer precursor(s) to polymerize, or 4) any other necessary condition. Thus, steps a) and b) may be performed 1) at a temperature below that needed for polymerization to occur, 2) in the absence of a catalyst and/or initiator compound, 3) in the absence of a curing agent necessary for polymerization and/or 4) any other condition necessary for polymerization. In preferred embodiments, the polymer precursor(s) require a curing agent to polymerize, and conditions of steps a) and a-1) (if performed) include the absence of such a curing agent.

In step b), the curable polymer precursor in the dispersed droplets is partially cured. The extent of curing performed in this step is 1 to 25% of full cure. “Full cure” for purposes of this invention means that all of the reactive groups in the dispersed polymer precursor droplets become reacted in a curing (polymerization) reaction. The extent of curing during curing step b) may be at least 2% or at least 3% of full cure. It is preferred to limit the cure in this step to at most 15%, more preferably at most 10% of full cure. As used herein, an extent of cure of XX % of full cure indicates that XX % of the original number of reactive groups in the curable polymer precursor in the dispersed droplets has reacted.

Curing is performed in step b) by subjecting the dispersed droplets to conditions necessary for curing to take place. In general, the dispersed droplets are subjected in step b) to all conditions necessary for the polymerization of the polymer precursor(s), including the condition or conditions which were absent during the dispersion step a) and optional preliminary droplet sizing step a-1) (if performed). Those conditions are maintained until the droplets are partially cured as described above. The conditions of the partial curing step therefore include 1) a temperature needed for polymerization to occur, 2) the presence of a catalyst and/or initiator compound if necessary for the curing reactions to take place, 3) the presence of a curing agent if necessary for the polymer precursor(s) to polymerize, and 4) any other necessary condition.

In preferred embodiments, the polymer precursor(s) require a curing agent or other added material to polymerize, and such a curing agent or other material is introduced and present during step b). After introduction, the curing agent or other material diffuses into or to the surface of the droplets. In such a preferred case, the curing agent or other material preferably is provided in step b) in an amount sufficient to effect the partial cure as described before. This allows the extent of cure in step b) to be controlled through selection of the amount of curing agent or other materials that is provided.

Step b) preferably is performed under conditions of agitation to maintain the polymer precursor in the form of droplets. Agitation also promotes the diffusion of any curing agent or other material added during step b) to effect the particle cure. Step b) preferably is performed under agitation conditions such that significant coalescence of the droplets does not occur. Significant coalescence is indicated by an increase in d₅₀ of at least 100%, compared to the droplet size at the conclusion of step a) (or preliminary sizing step a-1), if performed). When preliminary droplet sizing step a-1) has been performed, it is preferred to perform step b) under conditions of agitation such that the increase in d₅₀ is no more than 50%. In cases in which a material such as a curing agent, catalyst and/or initiator is added during step b) to effect the partial cure, some increase in droplet size may occur due to the transfer of this additional material into the dispersed droplets.

The conditions of agitation during step b) also preferably are such that a significant reduction in droplet size does not occur during the step, again especially if a preliminary droplet sizing step a-1) has been performed. A significant reduction is indicated by a decrease in d₅₀ of 25% or more compared to the droplet size at the conclusion of step a) (or step a-1), if performed).

In general, the conditions of agitation during step b) are less energetic than those employed in step a-1) (when performed). Typically, the necessary agitation can be provided by a stirred blade or blades in a tank or similar vessel, by conducting step b) while passing the dispersion through a static mixer, and similar means.

After the partial curing step b), the partially cured polymer precursor droplets are in the form of a liquid or partially gelled semi-solid. In such a state, the droplets remain susceptible to sizing in step c).

In step c), the droplets of the partially cured polymer precursor(s) are sized to a final target droplet size range. “Final” in this context means simply that no further sizing steps are performed after step c), before curing step d) is performed. Sizing is needed even if optional preliminary droplet sizing step a-1) is performed, because some coalescence of the droplets typically occurs during step b) despite the agitation and, in cases in which a curing agent, catalyst, initiator or other material is added in step b), some droplet growth will occur as a result of the added material diffusing into the dispersed droplets.

Homogenizers such as described with regard to the preliminary droplet sizing step a-1) are useful for performing sizing step c).

The final target droplet size produced in step c) may be the same or different than the preliminary target droplet size of step a-1). The final target droplet diameter range may be such that the d₅₀ diameter is, for example, 0.5 to 10 μm, 0.5 to 7 μm, or 0.5 to 5 μm, and/or the d₉₀ is up to 25 μm, up to 10 μm or 5 to 10 μm. The value of U for the sized droplets obtained from step c) may be up to 5, preferably up to 2.5 and more preferably up to 1.7.

In step d), the sized droplets obtained from step c) are cured to form solid particles. Curing is effected in the same general manner described with respect to step b), by subjecting the sized droplets to all conditions necessary for curing (polymerization) to take place. Preferably, the full curing step d) is performed by adding a curing agent, catalyst and/or initiator to the dispersion such that the added material diffuses to the droplets and participates in a reaction with the partially cured polymer precursor(s). Curing in this step is performed at least until solid polymer particles are formed. In some embodiments, curing is continued until at least 75%, at least 90% or at least 95% of the starting amount of reactive groups in the droplets (i.e., the number of reactive groups in the droplets after step a)) are consumed in the curing (polymerization) reaction.

Step d) is performed under non-resizing conditions. By non-resizing conditions, it is meant that no significant coalescence or significant droplet size reduction (each as described above) occurs. As in step b), an added material such as a curing agent, catalyst and/or initiator will result some increase in droplet size due to the transfer of this additional material into the dispersed droplets; however, this increase in general does not result in a droplet diameter increase of greater than 30%. Preferably, conditions in step d) are such that the polymer particles formed in this step have a d₅₀ which is 75 to 150%, more preferably 75 to 130% and even more preferably 90 to 110% of the final target particle size obtained in sizing step c), even in cases in which additional material is added to the dispersed droplets during the curing step d). The d₅₀ of the polymer particles formed in step d) may be 0.5 to 10 μm, preferably 0.5 to 7 μm and especially 0.5 to 5 μm; and/or the d₉₀ may be up to 25 μm, preferably up to 10 μm and more preferably 5 to 10 μm. As before, the value of U for the polymer particles may be up to 5, preferably up to 2.5 and more preferably up to 1.7.

The non-resizing conditions may include conditions of agitation such as described with respect b), such that the droplets do not significantly coalesce or become broken into smaller droplets until such time as they have cured enough to form solid polymer particles. The agitation may be performed in a stirred tank or other vessel, by passing the dispersion through a static mixer during at least a part of step d), or in another suitable manner.

Although the invention is not limited to any theory, it is believed that the low viscosity of the polymer precursor(s) during step a) (including preliminary sizing step a-1), if performed) permits the droplets to be sized somewhat easily to a preliminary target droplet size, which generally will be close to the size of the final particles. However, it is difficult to prevent coalescence and droplet growth for a time period long enough to cure the polymer precursors to the solid state. This is especially true if the curing is effected by adding materials such as curing agents, catalyst or initiators to the droplets, which requires a prolonged time due to the need to add those materials in a controlled manner such that they diffuse to the droplets. By performing only a partial polymerization in step b), the viscosity of the droplets increases. Some small amount of gelling may take place as well during this step, but solid particles are not formed. The increased viscosity makes the droplets less susceptible to coalescence, and at the same time is not so great that they cannot be resized.

In embodiments in which step a-1) is performed, some amount of coalescence and/or other changes in droplet size will typically occur during step b). But because in such a case the droplets are already sized (in step a-1)) close to the desired value, only a small amount of resizing is needed after step b). Because only a small amount of resizing is needed, it can be accomplished readily in step c) despite the increased viscosity (and possible partial gelation) of the droplets that occurs during step b). The sized droplets obtained from step c) are then easily polymerized without significant further coalescence. In this manner, close control over final particle size is obtained in an easily-operated process.

Having described the invention in general, a specific embodiment of the process will now be described with reference to the FIGURE.

In the FIGURE, the polymer precursor(s) and non-aqueous fluid are supplied to vessel 1, which as shown is a tank reactor. As shown, the polymer precursor(s) and non-aqueous fluid are supplied through lines 4 and 5, respectively, although it is within the scope of the invention to mix these before hand and introduce them into vessel 1 as a single stream. If added separately, the polymer precursor(s) and non-aqueous fluid can be added simultaneously or in any order. The polymer precursor(s) and non-aqueous fluid form dispersion 2 in vessel 1. Vessel 1 includes agitation means 3.

In the embodiment shown in the FIGURE, step a) of the process can be performed in vessel 1 by operating agitation means 3 to form a coarse dispersion. It is also possible to form the coarse dispersion outside of vessel 1, transfer the coarse dispersion to vessel 1 and operate agitation means 3 to maintain the coarse dispersion. Conditions during step a) are non-polymerizing conditions as described before. In some embodiments, agitation means 3 includes a mechanical agitator that includes one or more mixing elements that are at least partially submerged in dispersion 2. A preferred type of mechanical agitation means 3 is a coaxial agitator that includes an open impeller and a proximity impeller. The proximity impeller rotates adjacent to the vessel walls. It may have scrapers that keep the wall clean, promote process heat transfer to and from the walls of the vessel and act as baffles for the open impeller(s). The open impeller(s) rotate near the center of the vessel. Useful coaxial agitators include those manufactured by Ekato Group (Schopfheim, Germany), MGT Liquid & Process Systems (Industrial Zone Maalot, Israel) and PRG GmbH (Warburg, Germany).

Optional preliminary sizing step a-1) is performed by withdrawing dispersion 2 from vessel 1 via line 7 and passing the withdrawn dispersion through homogenizer 8, where the droplets of the coarse dispersion are sized to the first target particle size. Homogenizer 8 is generally as described before, and preferably includes a rotor-stator type mechanical agitator. After being preliminarily sized, the dispersion is then transferred back to tank 1 via line 9.

In an embodiment such as is shown in the FIGURE, the carrying capacity of lines 7 and 9 and homogenizer 8 is generally smaller than the total volume of the dispersion; therefore, some portion of the dispersion remains in vessel 1 at all times. The volume of dispersion 2 in vessel 1 preferably is great enough at all times to at least partially submerge agitation means 3. In such embodiments, the dispersion with preliminarily-sized polymer precursor droplet is returned from homogenizer 8 to vessel 1. Therefore, while preliminary sizing step a-1) is being performed, dispersion 2 in tank 1 will include both preliminarily sized and unsized droplets. The preliminary sizing step a-1) is not complete until the entire volume of dispersion 2 has passed through homogenizer 8 at least once. It may require several passes through homogenizer 8 to complete the preliminary sizing of the droplets and achieve the preliminary target droplet size. For example, the total volume of material passed through homogenizer 8 may be 2 to 20 times the total volume of fluid in vessel 1, to ensure that all of the material has been preliminarily sized to the preliminary target droplet size.

Once dispersion 2 has been formed (and the droplets have been preliminarily sized, (if step a-1) is performed), the polymer precursor in the droplets is partially cured. In the embodiment shown, a material necessary to cure the polymer precursor, such as a curing agent, catalyst or initiator, is introduced into vessel 1 via line 6. Agitation means 3 preferably operates during this step to minimize coalescence of the droplets, especially if they have been preliminarily sized, and to assist the added material to diffuse through the continuous phase to the droplets. If necessary, heating and/or cooling can be supplied to vessel 1 to maintain a temperature suitable for the partial curing. In addition, the rate of addition of the added material can be controlled to prevent an unwanted exothermic temperature increase. In embodiments in which a material is added to effect the cure, the partial curing takes place upon the addition of the added material.

Following the partial curing step b), sizing step c) is performed by again passing dispersion 2 through homogenizer 8. Note that dispersion 2 optionally may continue to be passed through homogenizer 8 during the partial curing step b). Thus, in some embodiments, dispersion 2 can be recirculated through line 7, homogenizer 8 and line 9 and back to vessel 1 continuously during steps a-1) (if performed), b) and c) of the process. In such embodiments, a portion of the partial curing step b) and the sizing step c) may take place simultaneously.

In the embodiment shown in the FIGURE, the curing step d) is performed in vessel 1. Additional material as may be needed to complete the cure (such as curing agent, catalyst and/or initiator) once again are added to vessel 1, such as through line 6. Agitation means 3 preferably is operated during this step to minimize droplet coalescence until solid particles form. It is preferred during this step to discontinue operation of homogenizer 8. As before, heat and/or cooling can be supplied to vessel 1 to maintain a suitable polymerization temperature.

In a specific process employing an apparatus as shown in the FIGURE, the starting materials are charged to vessel 1. Agitation means 3 is placed into operation before, during or after introducing the starting materials, and preferably remains in operation until solid polymer particles have formed in step d). Once a coarse dispersion forms in tank 1, recirculation stream is started through lines 7 and 9 and homogenizer 8. This recirculation stream can be operated continuously during the performance of steps a-1) (if performed), b) and c), or can be operated to perform preliminary sizing step a-1), discontinued during step b) and then recommenced during step c). Once a dispersion is formed (and) the preliminary target droplet size is achieved if step a-1) is performed), a needed additional material is introduced into vessel 1 via line 6 and the partial curing step b) is performed. The operation of agitation means 3 minimizes droplet coalescence during steps b) and d) while the dispersion remains in the reactor. Recirculation through lines 7 and 9 and homogenizer 8 is performed again after the additional material is added and the partial curing step b) is completed (and optionally during these steps as well), to size the partially cured droplets to the final target droplet size. The sized dispersion is then returned to tank 1 to complete the cure (step d)). Preferably, the recirculation stream is discontinued once the resizing step c) is completed.

An apparatus as shown in the FIGURE may contain various engineering features that are not shown; these include, for example, various pumps, flow control apparatus, heating and/or cooling apparatus, motors (for operating agitation means 3, for example), means for introducing and/or removing gas from the reactor head space, valving, gasketing, sensors of various types, spray heads (for dispersing materials added in one or more of lines 4, 5 and 6), computerized control mechanisms, and the like, which in each case may be used for their usual purpose.

The apparatus shown in the FIGURE is adapted for batch operation and has the advantage of low capital costs due in part to the use of vessel 1 to perform steps b) and d) of the process (and optionally step a) as well) and the use of a single recirculation system (lines 7 and 9 and homogenizer 8) for both the preliminary droplet sizing step a-1) (if performed) and sizing step c).

However, it is within the scope of the invention to perform the partial polymerization step b) in different equipment than that used to first mix the polymer precursor(s) and non-aqueous liquid to form the initial dispersion.

Similarly, it is within the scope of the invention to perform step d) in different equipment than that used to perform either or both of the initial mixing step a) and the partial polymerization step b).

For example, one can perform the initial mixing step in a first vessel, perform preliminary droplet sizing step a-1) and return the dispersion to the first vessel for partial polymerization step b). After performing sizing step c), the dispersion may be transferred to a second vessel for the final curing step d). An apparatus for such an embodiment may include a first vessel for performing the initial mixing and partial polymerization steps, a first homogenizer disposed in a recirculation loop as described above in fluid connection with the first vessel for performing preliminary droplet sizing step a-1) (if performed)), a second vessel for performing the final curing step d), and a second homogenizer, in fluid communication with both the first and second vessels, for performing sizing step c). In a variation of such an apparatus, a single homogenizer is provided to perform both preliminary droplet sizing step a-1) and sizing step c), together with piping and valving as necessary to permit transfer of the dispersion from the homogenizer to each of the first and second vessels, as appropriate.

In another embodiment, the initial mixing step is performed in a first vessel, and the partial polymerization step b) and final curing step d) are performed in a second vessel. An apparatus for such an embodiment may include a first vessel for performing the initial mixing to produce a coarse dispersion, and an optional first homogenizer disposed between the first vessel and a second vessel in which steps b) and d) are performed. The first homogenizer, if present, performs at least the preliminary sizing step a-1), and with appropriate piping and valving also can perform the sizing step c). Alternatively, a recirculation loop including a second homogenizer can be affixed to the second vessel to perform the sizing step c).

In another alternative embodiment, the initial mixing step a), partial curing step b) and final curing step d) are each performed in different vessels. With suitable equipment design, this embodiment is suitable for continuous operation. The equipment may include, in order, a static mixing or other device in which the non-aqueous fluid and polymer precursor are mixed and formed into a coarse dispersion; an optional first homogenizer in which the optional preliminary sizing step a-1) is performed; a second static mixing or other device in which the partial curing step b) is performed; a second homogenizer in which the sizing step c) is performed; and a final reaction vessel in which the final curing step d) is performed. The first static mixing or other device, the optional first homogenizer, the second static mixing or other device, the second homogenizer and the final reaction vessel are all operated in series, with each device in fluid communication with the next succeeding one. Continuous operation is achieved by establishing a continuous flow of the materials through the apparatus. The final reaction vessel may be, for example, a pipe reactor which optionally contains static mixing or other mixing elements, or a stirred tank or similar vessel.

In particular embodiment, step a) is performed by dispersing a solution of a conductive component in a one or more polyols into the non-aqueous liquid. The polyol preferably includes a homopolymer of ethylene oxide or a copolymer of at least 50 weight-% ethylene oxide and up to 50 weight-% propylene oxide. The non-aqueous liquid in this embodiment is preferably a polydimethylsiloxane or other silicone oil. In this embodiment, a surfactant, preferably a silicone surfactant that may have isocyanate-reactive groups such as primary or secondary amino groups, is included in step a), preferably by dissolving it into the non-aqueous fluid prior to performing step a), and then adding it together with the non-aqueous fluid. In this embodiment, step a) may be performed in a stirred vessel such as vessel 1 in the FIGURE, to form a coarse dispersion.

In this particular embodiment, optional step a-1) is conveniently performed by passing the coarse dispersion through a homogenizer such as a rotor-stator. As shown in the FIGURE, this step can be done by withdrawing a stream from vessel 1, passing through the homogenizer, and returning the stream to the vessel. This withdrawing, homogenizing and returning operation may be performed continuously throughout steps a-1), b) and c) of the process, by continuous operation of the corresponding equipment. Once the target droplet size is attained, one or more liquid polyisocyanate compounds are added to the dispersion, in an amount sufficient to consume 1 to 25% of the hydroxyl groups of the polyols(s). The liquid polyisocyanate compounds diffuse to the dispersed polyol droplets and react with the polyols(s) to partially cure the droplets.

Also in this particular embodiment, sizing step c) can be performed by again passing the dispersion through the homogenizer and returning the resized dispersion to the stirred vessel. Once sizing step c) is performed, additional polyisocyanate is added, in an amount sufficient to cure the dispersed droplets to form solid polymer particles. This step may be performed in stirred vessel 1 as shown in the figure. The additional polyisocyanate diffuses to the droplets, as before, where it reacts with the remaining polyol(s) to form the solid polymer particles.

Heating and/or cooling may be necessary or desirable to control the temperature of the dispersion during one or more of steps a)-d). The homogenization step in particular may heat the dispersion significantly. In addition, the curing reaction is in many cases exothermic, and it may be necessary to control the exothermic temperature rise to, for example, maintain a desirable reaction rate or otherwise prevent overheating that might cause degradation or boiling of one or more of the starting materials. Such control over the exothermic temperature rise can be achieved by, for example, controlling the rate of addition of any curing agent, catalyst or initiator and/or by applying cooling as necessary. Similarly, temperature increases due to the homogenization step can be controlled by applied cooling as may be necessary or desirable. Conversely, heating may be necessary in some cases to obtain an industrially useful polymerization rate.

The product of the process is a dispersion of polymer particles in the non-aqueous fluid. Any conductive component used in the process is dissolved in and/or at the surface of the dispersed polymer particles. In some embodiments, particularly when a conductive component is present, the dispersion is useful as an electrorheological fluid, for applications such as “tunable” vehicular suspension systems, hydraulic clutches, hydraulic valves, braking systems, devices for positioning and fixing workpieces, exercise and sport devices, and other variable mechanical resistance devices.

The following examples are provided to illustrate the invention, but are not intended to limit the scope thereof. All parts and percentages are by weight unless otherwise indicated.

The following starting materials are used in the following examples:

Non-aqueous fluid: Xiameter 200 5 cSt Silicone Oil (Dow Corning), a methyl-terminated polydimethyl siloxane having a kinematic viscosity of 5 centistokes.
Surfactant: Xiameter OFX8822 (Dow Corning), an amino-silicone surfactant having 0.46 meq/g of amine groups and a viscosity of 1500 centistokes.
Polymer Precursor: UCON TPEG 990 (Dow Chemical), a 1000 molecular weight, trifunctional, glycerine-initiated poly(ethylene oxide).

### Conductive Component: Lithium Chloride and Zinc Chloride

Catalyst: Crystalline triethylene diamine
Curing Agent: Isonate 50 O,P′-MDI, a diphenylmethanediisocyanate containing 50% of the 2,4′-isomer and 50% of the 2,6′-isomer.

### EXAMPLES 1-2

Example 1 is conducted at 1.5 kg scale in equipment such as is schematically shown in the FIGURE. Vessel 1 is a water-jacketed 1-gallon glass tank equipped with an overhead agitator and baffles. A nitrogen purge is established in the tank throughout the runs. A solution of conductive component, polymerization catalyst and polymer precursor (Table 1 below) is charged to the tank and covers the agitator blade. In a separate tank (not shown in the FIGURE), a mixture of surfactant and non-aqueous fluid is prepared. During the run, this non-aqueous fluid solution is delivered to Vessel 1 via line 5. Lines 7 and 9 are nominally ¼″ (6 mm) outer diameter, thermally insulated stainless steel tubing. Homogenizer 8 is an IKA Magic Lab Dispax Reactor outfitted with three rotor/stator stages in the succession coarse/medium/fine. The homogenizer is water-jacketed and insulated. Flow is established through line 7, homogenizer 8 and line 9 with a magnetically-driven gear pump operated at a flow rate of about 7 grams/minute, which increases to up to about 13 grams/minute when the rotor/stator is operating at high rotational speeds.

The following starting materials used in Example 1 are summarized in Table 1:

TABLE 1

| | |
|---|---|
| Ingredient | Parts by Weight |

Polymer Precursor Solution

| | |
|---|---|
| Polymer Precursor | 36.1 |
| Lithium Chloride | 0.060 |
| Zinc Chloride | 0.051 |
| Catalyst | 0.026 |

Non-Aqueous Fluid Solution

| | |
|---|---|
| Silicone Oil | 49.3 |
| Surfactant | 1.0 |

Curing Agent

| | |
|---|---|
| First Addition¹ | 0.7 |
| Second Addition | 12.7 |

¹This amount is sufficient to consume approximately 5% of the hydroxyl groups of the polymer precursor.

In Example 1, the polymer precursor solution is agitated in Vessel 1 at a rotational speed of 350 rpm. The non-aqueous fluid is pumped into Vessel 1 over the course of 60 seconds with continued stirring. The resulting mixture is stirred for 3 minutes to produce a coarse dispersion of polymer precursor solution droplets in the non-aqueous fluid (step a)). The dispersion is then recirculated through the rotor-stator and back to Vessel 1 at a rate of 10 g/s to perform the optional preliminary sizing step a-1). The preliminary droplet size d₅₀ is approximately 4 μm. The rotational speed of the rotor-stator is 20,000 rpm. Ten minutes after the rotor-stator is started, the first addition of curing agent is made by injecting the curing agent onto the surface of the liquid in Vessel 1 via a syringe over the course of 20 minutes. During this time, partial curing step b) and sizing step c) proceed simultaneously. The jacket temperature of vessel 1 is maintained at 25° C. during the rotor-stator operation, although viscous heat generation in the rotor-stator causes the emulsion temperature to increase to 41° C. Step c) is continued by further recirculating the dispersion through the rotor-stator for 10 additional minutes to size the droplets to a target droplet size d₅₀=3-4 μm. This is sufficient to provide about 4 additional volumetric turnovers of the contents of Vessel 1. The rotor-stator is then turned off, but recirculation through the rotor-stator is continued until the conclusion of the experiment.

The remainder of the curing agent is then added over the course of 25 minutes with agitation in vessel 1. The jacket temperature is then set to 60° C. The contents of vessel 1 are heated to that temperature over the course of an hour with continued agitation. The agitation prevents droplet coalescence but does not resize the droplets. The temperature is held at 60° C. for another two hours to complete the curing reaction and form solid particles. A sample is withdrawn from vessel 1 at this point and droplet size is measured by light-scattering methods using a Beckman Coulter LS 13 320 instrument with the Fraunhofer model with polymerization intensity differential scattering option enabled. The refractive index is set to 1.403 and the sample density estimated at 1.1 g/cc. The particles sizes range from about 1 to 10 μm with a peak at about 3-4 μm. Results are as indicated in Table 2.

TABLE 2

| Ex. No. | d₁₀, μm | d₅₀, μm | d₉₀, μm | U |
|---|---|---|---|---|
| 1 | 1.2 | 3.0 | 5.6 | 1.5 |
| 2 | 0.5 | 3.4 | 5.9 | 1.6 |

Example 2 is performed with the same composition employed in Example 1 at a 25 kg scale in a 50 liter Ekato Unimix apparatus outfitted with a coaxial mixing system, a Steriljet internal rotor-stator, a headspace nitrogen purge and a heating/cooling jacket set to maintain an internal temperature of 25° C. The polymer precursor, lithium chloride solution in a small portion of the polymer precursor and a zinc chloride solution in the remaining polymer precursor are blended in the tank. The catalyst is then added and stirred in until it dissolves. A mixture of the silicone oil and the surfactant are then pumped into the tank over 5 minutes. The resulting mixture is then agitated to form a coarse emulsion of polymer precursor droplets in the silicone oil.

The coarse emulsion is then pumped through a recirculation line through an IKA Process Pilot Dispax rotor stator at a nominal flow rate of 1.5 gallons per minute. The rotor-stator is operated at a rotational speed of 13,300 rpm. The recirculation is continued for 20 minutes to preliminarily size the polymer precursor droplets (step a-1) to a preliminary target droplet size of 3-5 μm. While continuing the recirculation, 21% of the first addition of curing agent is added to the surface of the emulsion in the tank over 24 minutes. Then remainder of the first addition of curing agent is made over another 6 minutes. The total amount of curing agent added to this point is sufficient to consume 5% of the hydroxyl groups of the polymer precursor. The emulsion is then recirculated through the rotor-stator for another 20 minutes to size the partially cured droplets (step c)).

The second addition of curing agent is then made to the agitated tank. The resulting mixture is then heated to 60° C. in the agitated tank, held at that temperature for 2 hours to cure the droplets to form polymer particles, and then cooled to 40° C. Particle size is measured as before. d₁₀ is 0.5 μm, d₅₀ is 3.4 μm, d₉₀ is 5.9 μm and U is 1.6. The apparent viscosity at 25° C. is approximately 40 mPa·s.

1. A method of forming a rheological fluid, comprising the steps of:
a) dispersing (1) at least one curable polymer precursor that has reactive groups which engage in a curing reaction to form a cured polymer into (2) a non-aqueous liquid in which the curable polymer precursor is substantially insoluble, to form a dispersion of droplets of the curable polymer precursor in a continuous phase of the non-aqueous liquid;
b) forming a partially cured dispersion by curing the curable polymer precursor in the dispersed droplets to the extent of 1 to 25% of full cure without solidifying the droplets, to form partially cured droplets;
c) sizing the partially cured droplets to a final target droplet size range; and then
d) under non-resizing conditions, curing the curable polymer precursor in the sized, partially cured droplets to form a dispersion of solid polymer particles in the non-aqueous fluid.

2. The method of claim 1, wherein in steps b) and d), the curable polymer precursor is cured by adding a curing agent and reacting the curing agent with the curable polymer precursor, wherein in step b) enough curing agent is added to react with 1 to 25 mole percent of the reactive groups of the curable polymer precursor.

3. The method of claim 2, wherein step c) is performed by passing the partially cured dispersion formed in step b) through a static mixer or rotor-stator.

4. The method of claim 2, wherein step a) includes a preliminary droplet sizing step a-1) in which the droplets are sized to a preliminary target particle size.

5. The method of claim 4, wherein step a-1) is performed by passing the dispersion formed in step a) through a static mixer or rotor-stator or both a static mixer and a rotor-stator.

6. The method of claim 5, wherein step a) is performed in an agitated tank reactor, and step a-1) is performed by withdrawing the dispersion formed in step a) from the tank reactor, passing the dispersion through a static mixer or rotor-stator or both a static mixer and a rotor-stator, and returning the dispersion to the agitated tank reactor.

7. The method of claim 6, wherein step b) is performed after step a-1) by adding a curing agent to the agitated tank reactor in an amount sufficient to react with 1 to 25 mole percent of the reactive groups of the curable polymer precursor, and reacting the curing agent with the curable polymer precursor.

8. The method of claim 7, wherein step c) is performed by withdrawing the dispersion formed in step b) from the tank reactor, passing the dispersion through a static mixer or rotor-stator or both a static mixer and a rotor-stator, and returning the dispersion to the tank reactor.

9. The method of claim 8, wherein step d) is performed after step c) by adding a curing agent to the tank reactor, and reacting the curing agent with the curable polymer precursor in the tank reactor.

10. The method of claim 1, wherein the curable polymer precursor is at least one polyol, and in steps b) and d), the curable polymer precursor is cured by reaction with at least one polyisocyanate.

11. The method of claim 1, wherein the non-aqueous liquid is hydrophobic and electrically non-conductive.

12. The method of claim 11, wherein
the non-aqueous fluid includes at least one silicone oil.

13. The method of claim 1, wherein the dispersion formed in step a) includes at least one surfactant.

14. The method of claim 13, wherein the surfactant has isocyanate-reactive groups.

15. The method of claim 1, wherein the curable polymer precursor has at least one inorganic salt dissolved therein.

16. The method of claim 1, wherein the final target droplet size range is characterized by a d₅₀ of 0.5 to 5 μm and a d₉₀ of up to 10 μm.

17. The method of claim 1, wherein the preliminary target droplet size range obtained in step a-1) is characterized by a d₅₀ diameter which is 75 to 130% of the final d₅₀ diameter.

18. The method of claim 1, wherein the droplets from in step a) are characterized by a d₅₀ of 0.5 to 5 μm and a d₉₀ of up to 10 μm.
